(19) United States
(12) Patent Application Publication
(10) Pub. No.: US 2010/0262388 A1
(43) Pub. Date: Oct. 14, 2010

(54) Providing Stress Information In An Ultrasound System

(76) Inventors: Dong Kuk Shin, Seoul (KR); Mok Kun Jeong, Seoul (KR); Hye Jung Kim, Seoul (KR)

Correspondence Address: JONES DAY, 222 EAST 41ST ST, NEW YORK, NY, 10017, US

(21) Appl. No.: 12/729,065

(22) Filed: Mar. 22, 2010

(30) Foreign Application Priority Data
Apr. 10, 2009 (KR) 10-2009-0031063

(51) Int. Cl. G01N 29/00; G01L 1/00

(52) U.S. Cl. 702/56; 702/42

(57) ABSTRACT

Embodiments for providing stress information in an ultrasound system are disclosed. In one embodiment, by way of non-limiting example, an ultrasound system comprises: an ultrasound data acquisition unit configured to transmit/receive ultrasound signals to/from a target object while applying a stress to the target object to thereby output first ultrasound data and to transmit/receive ultrasound signals to/from the target object while releasing the stress applied to the target object to thereby output second ultrasound data; and a processing unit configured to form stress information based on the first and second ultrasound data, wherein the stress information includes stress magnitude information, stress application period information and ultrasound probe gradient information.

### CROSS-REFERENCE TO RELATED APPLICATIONS

The present application claims priority from Korean Patent Application No. 10-2009-0031063 filed on Apr. 10, 2009, the entire subject matter of which is incorporated herein by reference.

### TECHNICAL FIELD

The present disclosure generally relates to ultrasound systems, and more particularly to providing stress information in an ultrasound system.

### BACKGROUND

Recently, an ultrasound system has been extensively used in the medical field due to its non-invasive and non-destructive nature. Modern high-performance ultrasound imaging systems and techniques are commonly used to produce two-dimensional ultrasound images and three-dimensional ultrasound images of internal features of patients.

Generally, the ultrasound image is displayed in a Brightness mode (B-mode) by using reflectivity caused by an acoustic impedance difference between the tissues of a target object. However, if the reflectivity of the target object is hardly different from those of the neighboring tissues such as tumor, cancer or the like, then it is not easy to discriminate the target object in the B-mode image. Further, an ultrasound elastic imaging technology has been developed to display an image of the target object by using mechanical characteristics of the target object. Such technology is very helpful for diagnosing lesions such as tumor or cancer, which is relatively stiffer than the neighboring tissues. When stress is uniformly applied to the target object, a variation of the tumor or cancer is typically smaller than those of the neighboring tissues. The elasticity of a tissue is measured by using ultrasound data obtained before and after applying stress to the target object.

A compression plate mounted on an ultrasound probe may be used to apply the stress to the target object. A user may press the compression plate on the target object to thereby apply the stress to the target object. In such a case, strain data cannot be obtained under the same stress since every user applies different stress. Thus, the video quality of an elastic image may be changed depending on the users.

### SUMMARY

Embodiments for providing stress information in an ultrasound system are disclosed herein. In one embodiment, by way of non-limiting example, an ultrasound system comprises: an ultrasound data acquisition unit configured to transmit/receive ultrasound signals to/from a target object while applying a stress to the target object to thereby output first ultrasound data and to transmit/receive ultrasound signals to/from the target object while releasing the stress applied to the target object to thereby output second ultrasound data; and a processing unit in communication with the ultrasound data acquisition unit and being configured to form stress information based on the first and second ultrasound data, wherein the stress information includes stress magnitude information, stress application period information and ultrasound probe gradient information.

In another embodiment, there is provided a method of providing stress information, comprising: a) transmitting/receiving ultrasound signals to/from a target object while applying a stress to the target object to thereby output first ultrasound data; b) transmitting/receiving ultrasound signals to/from the target object while releasing the stress applied to the target object to thereby output second ultrasound data; and c) forming stress information based on the first and second ultrasound data, wherein the stress information includes stress magnitude information, stress application period information and ultrasound probe gradient information.

In yet another embodiment, there is provided a computer readable medium comprising computer executable instructions configured to perform the following acts: a) transmitting/receiving ultrasound signals to/from a target object while applying a stress to the target object to thereby output first ultrasound data; b) transmitting/receiving ultrasound signals to/from the target object while releasing the stress applied to the target object to thereby output second ultrasound data; and c) forming stress information based on the first and second ultrasound data, wherein the stress information includes stress magnitude information, stress application period information and ultrasound probe gradient information.

The Summary is provided to introduce a selection of concepts in a simplified form that are further described below in the Detailed Description. This Summary is not intended to identify key or essential features of the claimed subject matter, nor is it intended to be used in determining the scope of the claimed subject matter.

### BRIEF DESCRIPTION OF THE DRAWINGS

FIG. 1 is a block diagram showing an ultrasound system in accordance with a first embodiment.

FIG. 2 is a block diagram showing an ultrasound data acquisition unit in accordance with the first embodiment.

FIG. 3 is a block diagram showing a processing unit in accordance with the first embodiment.

FIG. 4 is a schematic diagram showing an example of frames, elastic image frames, scan-lines and stress application periods.

FIGS. 5 to 8 are schematic diagrams showing an example of stress information.

FIG. 9 is a block diagram showing an ultrasound system in accordance with a second embodiment.

FIG. 10 is a block diagram showing a processing unit in accordance with the second embodiment.

### DETAILED DESCRIPTION

A detailed description may be provided with reference to the accompanying drawings. One of ordinary skill in the art may realize that the following description is illustrative only and is not in any way limiting. Other embodiments of the present invention may readily suggest themselves to such skilled persons having the benefit of this disclosure.

### First Embodiment

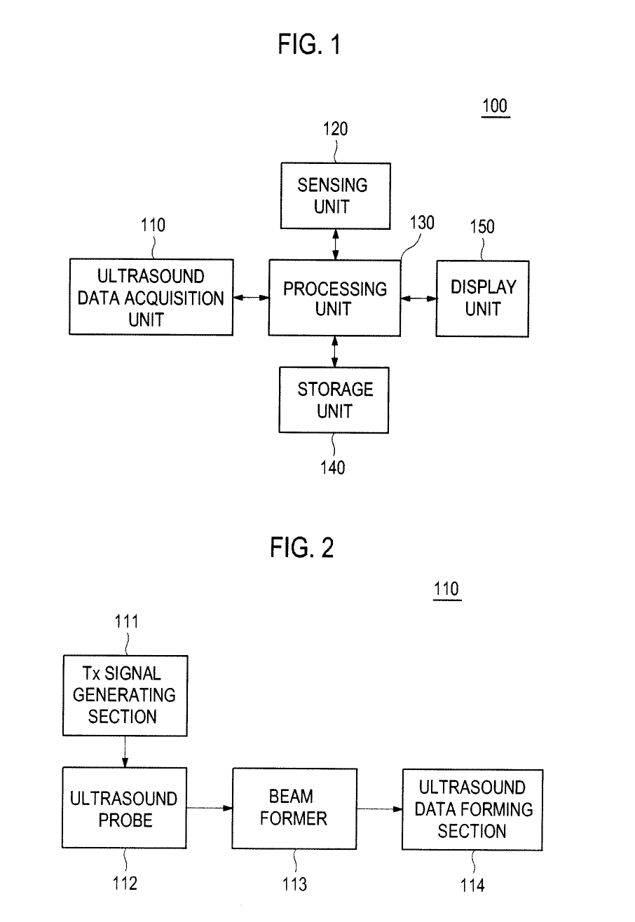

Referring to FIG. 1, an ultrasound system 100 in accordance with an illustrative embodiment is shown. As depicted therein, the ultrasound system 100 may include an ultrasound data acquisition unit 110. The ultrasound data acquisition unit 110 may be configured to transmit/receive ultrasound signals to/from a target object to thereby acquire ultrasound data.

Referring to FIG. 2, the ultrasound data acquisition unit 110 may include a transmit (Tx) signal generating section 111. The Tx signal generating section 111 may be configured to generate first Tx signals while applying stress to the target object (“first time duration”). The Tx signal generating section 111 may be further configured to generate second Tx signals while releasing the stress applied to the target object (“second time duration”).

The ultrasound data acquisition unit 110 may further include an ultrasound probe 112 containing a plurality of elements for reciprocally converting between ultrasound signals and electrical signals. The ultrasound probe 112 may deliver the stress provided from an external to the target object. The ultrasound probe 112 may be configured to transmit ultrasound signals into the target object in response to the first Tx signals. The ultrasound probe 112 may be further configured to receive echo signals reflected from the target object (which received the first Tx signals) to thereby output first received signals. The ultrasound probe 112 may be also configured to transmit ultrasound signals into the target object in response to the second Tx signals. Moreover, the ultrasound probe 112 may be configured to the receive echo signals reflected from the target object (which received the second Tx signals) to thereby output second received signals.

The ultrasound data acquisition unit 110 may further include a beam former 113. The beam former 113 may be configured to convert the first received signals into first digital signals. The beam former 113 may be additionally configured to apply delays to the first digital signals in consideration of distance between the elements and focal points to thereby output first digital receive-focused signals. The beam former 113 may be further configured to convert the second received signals into second digital signals. The beam former 113 may be further configured to apply delays to the second digital signals in consideration of distance between the elements and the focal points to thereby output second digital receive-focused signals.

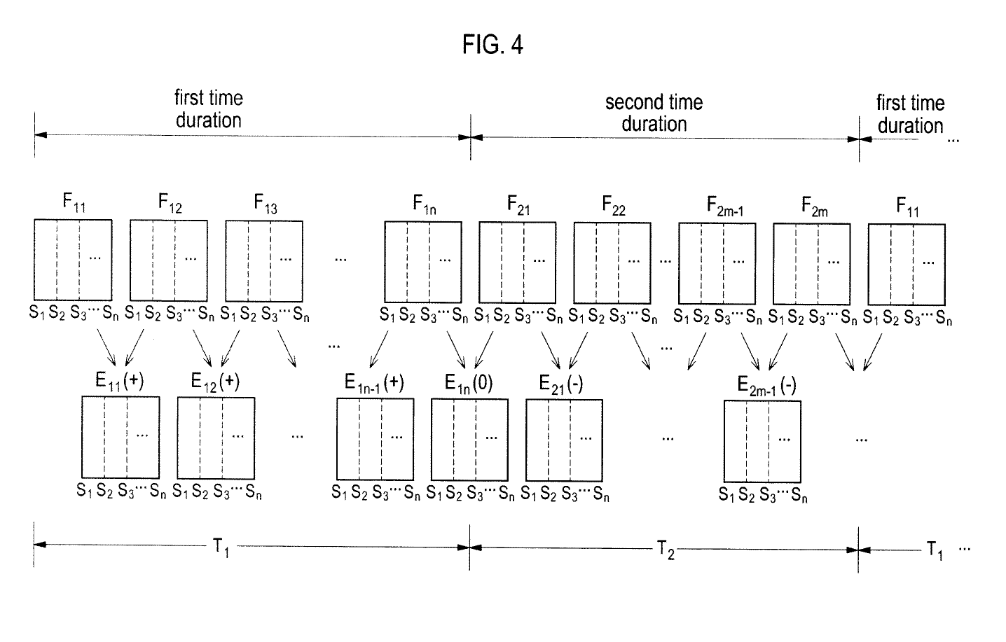

The ultrasound data acquisition unit 110 may further include an ultrasound data forming section 114. The ultrasound data forming section 114 may be configured to form first ultrasound data corresponding to each of first frames F₁₁ to F₁ₙ based on the first digital receive-focused signals, as shown in FIG. 4. The ultrasound data forming section 114 may be further configured to form second ultrasound data corresponding to each of second frames F₂₁ to F₂ₘ based on the second digital receive-focused signals, as shown in FIG. 4. The first and second ultrasound data may be radio frequency (RF) data or in-phase/quadrature (IQ) data.

Referring back to FIG. 1, the ultrasound system 100 may further include a sensing unit 120. The sensing unit 120 may be configured to sense stress magnitude to thereby output the sensed stress magnitude signals. The sensing unit 120 may be attached to one side of a scan surface of the ultrasound probe 112.

The ultrasound system 100 may further include a processing unit 130 placed in communication with the ultrasound data acquisition unit 110 and the sensing unit 120. The processing unit 130 may be configured to form stress information based on the first and second ultrasound data provided from the ultrasound data acquisition unit 110 and the sensed stress magnitude signals provided from the sensing unit 120. The stress information may include stress magnitude information, stress application period information and ultrasound probe gradient information. Thus, a user may appropriately apply the stress to the target object by referring to the stress information displayed on a display unit 150. The processing unit 130 may be further configured to form an elastic image based on the first and second ultrasound data.

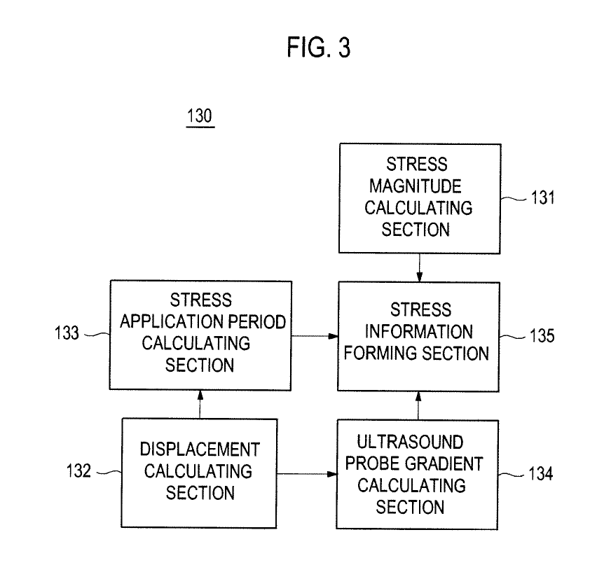

Referring to FIG. 3, the processing unit 130 may include a stress magnitude calculating section 131, a displacement calculating section 132, a stress application period calculating section 133, an ultrasound probe gradient calculating section 134 and a stress information forming section 135.

The stress magnitude calculating section 131 may be configured to calculate stress magnitudes based on the sensed stress magnitude signals provided from the sensing unit 120. The methods of calculating the stress magnitude based on the sensed stress magnitude signals are well known in the art. Thus, they have not been described in detail so as not to unnecessarily obscure the present invention.

The displacement calculating section 132 may be configured to calculate displacements based on the first and second ultrasound data between the neighboring frames. The displacement may be calculated by using an auto-correlation method or a cross-correlation method. Referring to FIG. 4, in one embodiment, the displacement calculating section 132 may be configured to calculate displacements corresponding to each of scan-lines S₁ to Sₙ of an elastic image frame E₁₁ based on the ultrasound data between the neighboring frames F₁₁ and F₁₂, as shown in FIG. 4. Similarly, the displacement calculating section 132 may be further configured to calculate displacements corresponding to each of scan-lines S₁ to Sₙ of elastic image frames E₁₂, . . . , E₁ₙ₋₁, E₁ₙ, E₂₁, . . . , E₂ₘ₋₁ based on the ultrasound data between the neighboring frames F₁₂, F₁₃, . . . F₂ₘ₋₁ and F₂ₘ. In one embodiment, by way of non-limiting example, the displacements at the first time duration may have a positive sign, while the displacements at the second time duration may have a negative sign.

The stress application period calculating section 133 may be configured to calculate stress application periods based on the displacements provided from the displacement calculating section 132. In one embodiment, the stress application period calculating section 133 may be configured to calculate first time durations T₁ based on the displacements having the positive sign, and calculate second time durations T₂ based on the displacements having the negative sign, as shown in FIG. 4.

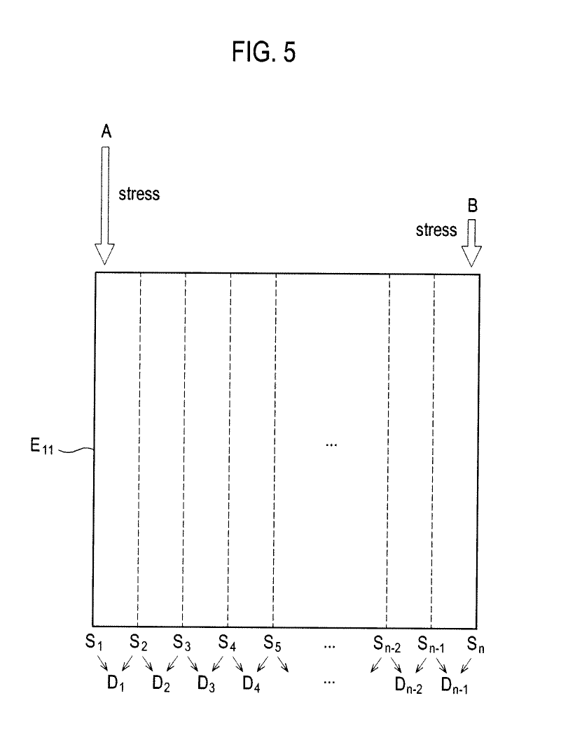

The magnitude of the stress, which is applied to the target object (not shown), may be changed along the scan-lines S₁ to Sₙ. As shown in FIG. 5, the magnitude of the stress of the left side A may be larger than that of the right side B. The ultrasound probe gradient calculating section 134 may be configured to calculate ultrasound probe gradients of the ultrasound probe 112 based on the displacements provided from the displacement calculating section 132. In one embodiment, the ultrasound probe gradient calculating section 134 may be configured to calculate displacement differences D₁, D₂, . . . , Dₙ₋₁ between the displacements corresponding to the neighboring scan-lines of the elastic image frame E₁₁ as shown in FIG. 5. The ultrasound probe gradient calculating section 134 may be further configured to calculate an ultrasound probe gradient based on the calculated displacement differences. Similarly, the ultrasound probe gradient calculating section 134 may be further configured to calculate the displacement differences D₁, D₂, . . . , Dₙ₋₁ between the displacements corresponding to the neighboring scan-lines of the elastic image frames E₁₂, . . . , E₁ₙ₋₁, E₁ₙ, E₂₁, . . . , E₂ₘ₋₁ and to calculate the ultrasound probe gradients based on the calculated displacement differences.

The stress information forming section 135 may be configured to form the stress information based on the stress magnitudes provided from the stress magnitude calculating section 131, the stress application periods provided from the stress application period calculating section 133 and the ultrasound probe gradients provided from the ultrasound probe gradient calculating section 134.

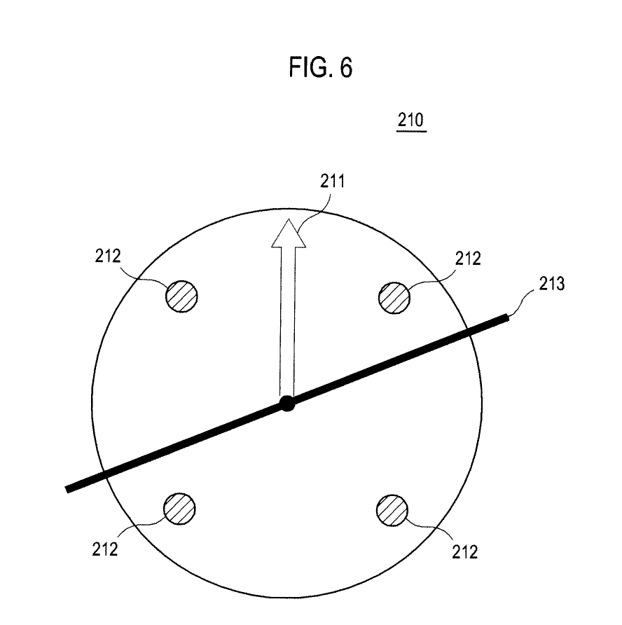

In one embodiment, the stress information forming section 135 may be configured to form stress magnitude information 211 representing the stress magnitude provided from the stress magnitude calculating section 131 as a size of a first symbol (e.g., arrow) based on the predetermined stress magnitude, as shown in FIG. 6. The stress information forming section 135 may be further configured to form stress application period information 212 representing the stress application period provided from the stress application period calculating section 133 as a second symbol (e.g., circle) based on the predetermined stress application period. If the stress application period provided from the stress application period calculating section 133 is faster than the predetermined stress application period, then the stress information forming section 135 may be configured to form the stress application period information 212 representing a color of the second symbol as red (not shown). If the stress application period provided from the stress application period calculating section 133 is equal to the predetermined stress application period, then the stress information forming section 135 may be configured to form the stress application period information 212 representing the color of the second symbol as blue (not shown). If the stress application period provided from the stress application period calculating section 133 is slower than the predetermined stress application period, then the stress information forming section 135 may be configured to form the stress application period information 212 representing the color of the second symbol as black (not shown). The stress information forming section 135 may be further configured to form ultrasound probe gradient information 213 representing the ultrasound probe gradient provided from the ultrasound probe gradient calculating section 134 as a gradient of a third symbol. The stress information forming section 135 may be configured to form stress information 210 including the stress magnitude information 211, the stress application period information 212 and the ultrasound probe gradient information 213.

In other embodiment, the stress information forming section 135 may be configured to form stress magnitude information representing the stress magnitude provided from the stress magnitude as a size and color of the first symbol such as the arrow (not shown). If the stress magnitude provided from the stress magnitude calculating section 131 is larger than the predetermined stress magnitude, then the stress information forming section 135 may be configured to form the stress magnitude information representing the color of the first symbol as red (not shown). If the stress magnitude provided from the stress magnitude calculating section 131 is equal to the predetermined stress magnitude, then the stress information forming section 135 may be configured to form the stress magnitude information representing the color of the first symbol as blue (not shown). If the stress magnitude provided from the stress magnitude calculating section 131 is smaller than the predetermined stress magnitude, then the stress information forming section 135 may be configured to form the stress magnitude information representing the color of the first symbol as black (not shown). The stress information forming section 135 may form stress application period information, ultrasound probe gradient information and stress information, as described in the foregoing embodiment.

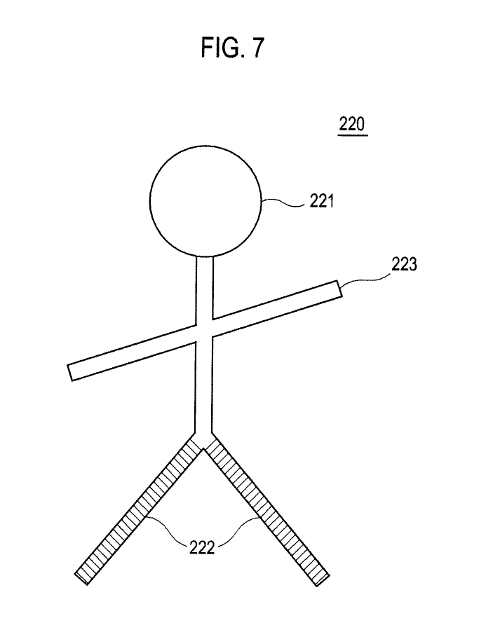

In another embodiment, the stress information forming section 135 may be configured to form stress magnitude information 221 representing the stress magnitude provided from the stress magnitude calculating section 131 as an expression of a character based on the predetermined stress magnitude as shown in FIG. 7. If the stress magnitude provided from the stress magnitude calculating section 131 is equal to the predetermined stress magnitude, then the stress information forming section 135 may be configured to form the stress magnitude information 221 representing the stress magnitude provided from the stress magnitude calculating section 131 as a smile expression (not shown) of the character. If the stress magnitude provided from the stress magnitude calculating section 131 is not equal to the predetermined stress magnitude, then the stress information forming section 135 may be configured to form the stress magnitude information 221 representing the stress magnitude provided from the stress magnitude calculating section 131 as a wry expression (not shown) of the character. The stress information forming section 135 may be further configured to form stress application period information 222 representing the stress application period provided from the stress application period calculating section 133 as a motion and a color of legs of the character. If the stress application period provided from the stress application period calculating section 133 is faster than the predetermined stress application period, then the stress information forming section 135 may be configured to form the stress application period information 222 representing the color of the legs as red (not shown). If the stress application period provided from the stress application period calculating section 133 is equal to the predetermined stress application period, then the stress information forming section 135 may be configured to form the stress application period information 222 representing the color of the legs as blue (not shown). If the stress application period provided from the stress application period calculating section 133 is slower than the predetermined stress application period, then the stress information forming section 135 may be configured to form the stress application period information 222 representing the color of the legs as black (not shown). The stress information forming section 135 may be further configured to form ultrasound probe gradient information 223 representing the ultrasound probe gradient provided from the ultrasound probe gradient calculating section 134 as a gradient of arms of the character. The stress information forming section 135 may be configured to stress information 220 including the stress magnitude information 221, the stress application period information 222 and the ultrasound probe gradient information 223.

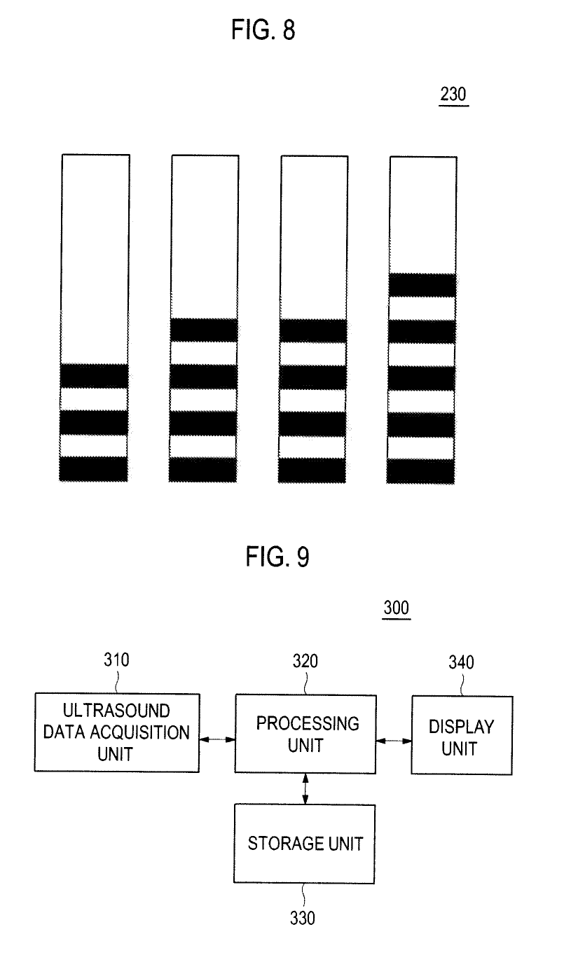

In yet another embodiment, the stress information forming section 135 may be configured to form stress magnitude information representing the stress magnitude provided from the stress magnitude calculating section 131 as a height of graph bar based on the predetermined stress magnitude as shown in FIG. 8. The stress information forming section 135 may be further configured to form stress application period information representing the stress application period provided from the stress application period calculating section 133 as a color of the graph bar based on the predetermined stress application period as shown in FIG. 8. If the stress application period provided from the stress application period calculating section 133 is faster than the predetermined stress application period, then the stress information forming section 135 may be configured to form the stress application period information representing the color of the graph bar as red (not shown). If the stress application period provided from the stress application period calculating section 133 is equal to the predetermined stress application period, then the stress information forming section 135 may be configured to form the stress application period information representing the color of the graph bar as blue (not shown). If the stress application period provided from the stress application period calculating section 133 is slower than the predetermined stress application period, then the stress information forming section 135 may be configured to form the stress application period information representing the color of the graph bar as black (not shown). The stress information forming section 135 may be further configured to form ultrasound probe gradient information representing the ultrasound probe gradient as a gradient of graph bar. The guide information forming section 135 may be further configured to form guide information 230 including the stress magnitude information, the stress application period information and the ultrasound probe gradient information.

While the stress magnitude, the stress application period and the ultrasound probe gradient are represented as the symbol and/or the color in foregoing embodiments, the stress magnitude, the stress application period and the ultrasound probe gradient are represented as at least one of a symbol, a graph, numerical value, text and colors.

Referring back to FIG. 1, the ultrasound system 100 may further include a storage unit 140. The storage unit 140 may store the ultrasound data acquired from the ultrasound data acquisition unit 110. The storage unit 140 may further store the stress information formed from the processing unit 130.

The ultrasound system 100 may further include the display unit 150. The display unit 150 may display the stress information formed from the processing unit 130. The display unit 150 may further display the elastic image formed from the processing unit 130.

### Second Embodiment

Referring to FIG. 9, an ultrasound system 300 in accordance with a second embodiment is shown. As depicted therein, the ultrasound system 300 may include an ultrasound data acquisition unit 310. The ultrasound data acquisition unit 310 may be configured to transmit/receive ultrasound signals to/from a target object to thereby acquire ultrasound data. The ultrasound data acquisition unit 310 in the second embodiment is similar to the ultrasound data acquisition unit 110 in the first embodiment shown in FIG. 1. Thus, the ultrasound data acquisition unit 310 in the present embodiment has not been described in detail.

The ultrasound system 300 may further include processing unit 320. The processing unit 320 may be configured to form stress information based on the ultrasound data provided from the ultrasound data acquisition unit 310. The stress information may include stress magnitude information, stress application period information and ultrasound probe gradient information. Thus, a user may appropriately apply the stress to the target object by referring to the stress information. The processing unit 320 may be further configured to form an elastic image based on the ultrasound data.

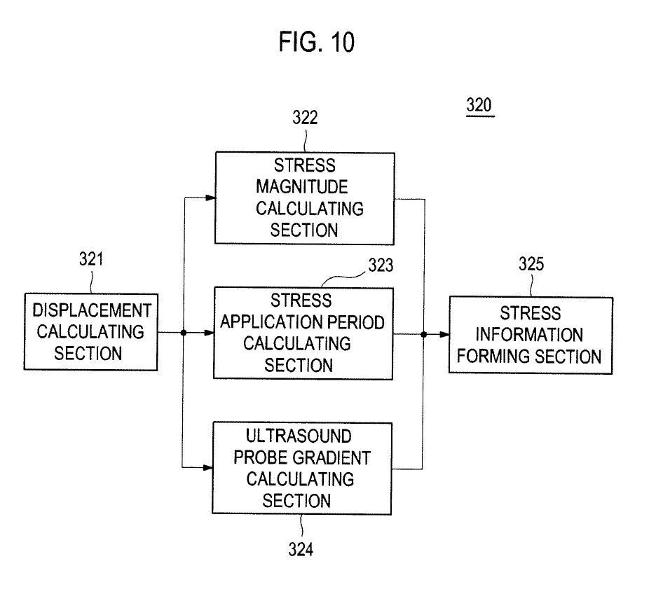

FIG. 10 is a block diagram showing an illustrative embodiment of the processing unit 320. Referring to FIG. 10, the processing unit 320 may include a displacement calculating section 321, a stress magnitude calculating section 322, a stress application period calculating section 323, an ultrasound probe gradient calculating section 324 and a stress information forming section 325.

The displacement calculating section 321 may be configured to calculate displacements based on the ultrasound data between the neighboring frames. The displacement may be calculated by using an auto-correlation method or a cross-correlation method. The displacement calculating section 321 in the second embodiment is similar to the displacement calculating section 132 shown in FIG. 3. Thus, it has not been described in detail.

The stress magnitude calculating section 322 may be configured to calculate stress magnitudes corresponding to each of scan-lines S₁ to Sₙ of elastic image frames E₁₁, E₁₂, . . . , E₁ₙ₋₁, E₁ₙ, E₂₁, . . . , E₂ₘ₋₁ based on the displacements provided from the displacement calculating section 321, as shown in FIG. 4. The methods of calculating the stress magnitude based on the displacements are well known in the art. Thus, they have not been described in detail so as not to unnecessarily obscure the present invention.

The stress application period calculating section 323 may be configured to calculate stress application periods based on the displacements provided from the displacement calculating section 321. The stress application period calculating section 323 in the second embodiment is similar to the stress application period calculating section 133 in the first embodiment shown in FIG. 3. Thus, it has not been described in detail.

The ultrasound probe gradient calculating section 324 may be configured to calculate ultrasound probe gradients of the ultrasound probe 112 based on the displacements provided from the displacement calculating section 321. The ultrasound probe gradient calculating section 324 in the second embodiment is similar to the ultrasound probe gradient calculating section 134 in the first embodiment shown in FIG. 3. Thus, it has not been described in detail.

The stress information forming section 325 may be configured to form the stress information including the stress magnitude information, the stress application period information and the ultrasound probe gradient information based on the stress magnitudes, the stress application periods and the ultrasound probe. The stress information forming section 325 in the second embodiment is similar to the stress information forming section 135 in the first embodiment shown in FIG. 3. Thus, it has not been described in detail.

Referring back to FIG. 9, the ultrasound system 300 may further include a storage unit 330. The storage unit 330 may store the ultrasound data acquired from the ultrasound data acquisition unit 310. The storage unit 330 may further store the stress information formed from the processing unit 320.

The ultrasound system 300 may further include a display unit 340. The display unit 340 may display the stress information formed from the processing unit 320. The display unit 340 may further display the elastic image formed from the processing unit 320.

In another embodiment, the present invention may provide a computer readable medium comprising computer executable instructions configured to perform following acts: a) transmitting/receiving ultrasound signals to/from a target object while applying a stress to the target object to thereby output first ultrasound data; b) transmitting/receiving ultrasound signals to/from the target object while releasing the stress applied to the target object to thereby output second ultrasound data; and c) forming stress information based on the first and second ultrasound data, wherein the stress information includes stress magnitude information, stress application period information and ultrasound probe gradient information. The computer readable medium may comprise a floppy disk, a hard disk, a memory, a compact disk, a digital video disk, etc.

Although embodiments have been described with reference to a number of illustrative embodiments thereof, it should be understood that numerous other modifications and embodiments can be devised by those skilled in the art that will fall within the spirit and scope of the principles of this disclosure. More particularly, numerous variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An ultrasound system, comprising:
an ultrasound data acquisition unit configured to transmit/receive ultrasound signals to/from a target object while applying a stress to the target object to thereby output first ultrasound data and to transmit/receive ultrasound signals to/from the target object while releasing the stress applied to the target object to thereby output second ultrasound data; and
a processing unit in communication with the ultrasound data acquisition unit and being configured to form stress information based on the first and second ultrasound data, wherein the stress information includes stress magnitude information, stress application period information and ultrasound probe gradient information.

2. The ultrasound system of claim 1, wherein the stress information includes at least one of a symbol, a graph, numerical value, text and colors.

3. The ultrasound system of claim 1, further comprising a sensing unit in communication with the processing unit, the sending unit being configured to sense stress magnitude to thereby transmit the sensed stress magnitude signals to the processing unit.

4. The ultrasound system of claim 3, wherein the processing unit comprises:
a stress magnitude calculating section configured to calculate stress magnitudes based on the sensed stress magnitude signals;
a displacement calculating section configured to calculate displacements based on the first and second ultrasound data;
a stress application period calculating section configured to calculate stress application periods based on the calculated displacements;
an ultrasound probe gradient calculating section configured to calculate ultrasound probe gradients based on the calculated displacements; and
a stress information forming section configured to form the stress magnitude information based on the calculated stress magnitudes, form the stress application period information based on the calculated stress application periods and form the ultrasound probe gradient information based on the calculated ultrasound probe gradients, the stress information forming section being further configured to form the stress information including the stress magnitude information, the stress application period information and the ultrasound probe gradient information.

5. The ultrasound system of claim 1, wherein the processing unit comprises:
a displacement calculating section configured to calculate displacements based on the first and second ultrasound data;
a stress magnitude calculating section configured to calculate stress magnitudes based on the calculated displacements;
a stress application period calculating section configured to calculate stress application periods based on the calculated displacements;
an ultrasound probe gradient calculating section configured to calculate ultrasound probe gradients based on the calculated displacements; and
a stress information foaming section configured to form the stress magnitude information based on the calculated stress magnitudes, form the stress application period information based on the calculated stress application periods and form the ultrasound probe gradient information based on the calculated ultrasound probe gradients, the stress information forming section being further configured to form the stress information including the stress magnitude information, the stress application period information and the ultrasound probe gradient information.

6. A method of providing stress information, comprising:
a) transmitting/receiving ultrasound signals to/from a target object while applying a stress to the target object to thereby output first ultrasound data;
b) transmitting/receiving ultrasound signals to/from the target object while releasing the stress applied to the target object to thereby output second ultrasound data; and
c) forming stress information based on the first and second ultrasound data, wherein the stress information includes stress magnitude information, stress application period information and ultrasound probe gradient information.

7. The method of claim 6, wherein the stress information includes at least one of a symbol, a graph, numerical value, text, colors.

8. The method of claim 6, further comprising the step of sensing stress magnitude to thereby output the sensed stress magnitude signals.

9. The method of claim 8, wherein the step c) comprises:
calculating stress magnitudes based on the sensed stress magnitude signals;
calculating displacements based on the first and second ultrasound data;
calculating stress application periods based on the calculated displacements;
calculating ultrasound probe gradients based on the calculated displacements;
forming the stress magnitude information based on the calculated stress magnitudes;
forming the stress application period information based on the calculated stress application periods;
forming the ultrasound probe gradient information based on the calculated ultrasound probe gradients; and
forming the stress information including the stress magnitude information, the stress application period information and the ultrasound probe gradient information.

10. The method of claim 6, wherein the step c) comprises:
calculating displacements based on the first and second ultrasound data;
calculating stress magnitudes based on the calculated displacements;
calculating stress application periods based on the calculated displacements;
calculating ultrasound probe gradients based on the calculated displacements;
forming the stress magnitude information based on the calculated stress magnitudes;
forming the stress application period information based on the calculated stress application periods;
forming the ultrasound probe gradient information based on the calculated ultrasound probe gradients; and
forming the stress information including the stress magnitude information, the stress application period information and the ultrasound probe gradient information.

11. A computer readable medium comprising computer executable instructions configured to perform following acts:
a) transmitting/receiving ultrasound signals to/from a target object while applying a stress to the target object to thereby output first ultrasound data;
b) transmitting/receiving ultrasound signals to/from the target object while releasing the stress applied to the target object to thereby output second ultrasound data; and
c) forming stress information based on the first and second ultrasound data, wherein the stress information includes stress magnitude information, stress application period information and ultrasound probe gradient information.

12. The computer readable medium of claim 11, wherein the stress information includes at least one of a symbol, a graph, numerical value, text, colors.

13. The computer readable medium of claim 11, further comprising the step of sensing stress magnitude to thereby output the sensed stress magnitude signals.

14. The computer readable medium of claim 13, wherein the step c) comprises:
calculating stress magnitudes based on the sensed stress magnitude signals;
calculating displacements based on the first and second ultrasound data;
calculating stress application periods based on the calculated displacements;
calculating ultrasound probe gradients based on the calculated displacements;
forming the stress magnitude information based on the calculated stress magnitudes;
forming the stress application period information based on the calculated stress application periods;
forming the ultrasound probe gradient information based on the calculated ultrasound probe gradients; and
forming the stress information including the stress magnitude information, the stress application period information and the ultrasound probe gradient information.

15. The computer readable medium of claim 11, wherein the step c) comprises:
calculating displacements based on the first and second ultrasound data;
calculating stress magnitudes based on the calculated displacements;
calculating stress application periods based on the calculated displacements;
calculating ultrasound probe gradients based on the calculated displacements;
forming the stress magnitude information based on the calculated stress magnitudes;
forming the stress application period information based on the calculated stress application periods;
forming the ultrasound probe gradient information based on the calculated ultrasound probe gradients; and
forming the stress information including the stress magnitude information, the stress application period information and the ultrasound probe gradient information.
